(19) United States
(12) Patent Application Publication
(10) Pub. No.: US 2006/0281634 A1
(43) Pub. Date: Dec. 14, 2006

(54) Thermo-sensitive recording medium and apparatus and method for forming multi-color image on the recording medium

(75) Inventor: Jae-hwan Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/415,283

(22) Filed: May 2, 2006

(30) Foreign Application Priority Data
Jun. 14, 2005 (KR) 10-2005-0051134

(51) Int. Cl. B41M 5/20

(52) U.S. Cl. 503/204; 428/204

(57) ABSTRACT

A thermo-sensitive recording medium, a thermo-sensitive recording apparatus and method for forming a multi-color image on the thermo-sensitive recording medium are provided. The thermo-sensitive recording medium includes: a transparent base layer limiting thermal color-rendering interference; a first thermo-sensitive recording layer stacked on the base layer for producing a first color by heating; a second thermo-sensitive recording layer formed under the base layer for producing a second color by heating; and a thermo-sensitive magnetic recording layer which is formed under the second thermo-sensitive recording layer, and having a matrix resin that melts by heating until it reaches a fluid state, and in which a plurality of third colored magnetic particles are uniformly dispersed in the lower portion of the matrix resin.

### CROSS-REFERENCE TO RELATED PATENT APPLICATION

This application claims the benefit of Korean Patent Application No. 10-2005-0051134, filed on Jun. 14, 2005, in the Korean Intellectual Property Office, the disclosure of which is incorporated by reference herein in its entirety.

### BACKGROUND OF THE INVENTION

1. Field of the Invention

The present invention relates to a thermo-sensitive recording medium on which a multi-color image can be formed, a thermo-sensitive recording apparatus and a method for forming a multi-color image on the thermo-sensitive recording medium.

2. Description of the Related Art

In a thermo-sensitive method for printing an image, a color image is printed by selectively applying thermal energy to a thermo-sensitive recording medium. Recently, approaches for forming multi-color images as well as monochrome images have been actively researched.

FIG. 1 is a cross-sectional view of a conventional thermo-sensitive recording medium disclosed in Japanese Patent Laid-Open Gazette Hei 3-288688. Referring to FIG. 1, a thermo-sensitive recording medium 50 includes a base layer 10, a cyan recording layer 20, a magenta recording layer 30, and a yellow recording layer 40, which are sequentially stacked on the base layer 10. When the recording layers 20, 30, and 40 are heated up to respective predetermined color-rendering temperatures, different colors, such as cyan, magenta, and yellow are respectively rendered on the recording layers 20, 30, and 40. A protecting layer 45 covering the thermo-sensitive recording medium 50 protects thermally and mechanically the recording layers 20, 30, and 40.

FIG. 2 is s schematic view illustrating the structure of a thermo-sensitive printer forming an image on a thermo-sensitive recording medium as shown in FIG. 1. Referring to FIG. 2, a roll type thermo-sensitive recording medium 50 loaded in the thermo-sensitive printer is transported along one direction and colors are rendered on the thermo-sensitive recording medium 50 to form an image. Initially, a first thermal head 60Y applies thermal energy of a relatively low level to the thermo-sensitive recording medium 50, thereby rendering yellow color in the yellow recording layer 40. Next, an operation of fixing the yellow image formed in the yellow recording layer 40 is performed. That is, a first ultraviolet ray lamp 70Y irradiates ultraviolet rays of about 420 nm band so as not to damage the image formed on the yellow recording layer 40 during the following color-rendering processes. Next, a second thermal head 60M applies thermal energy of an intermediate level to render magenta color in the magenta recording layer 30 and a second ultraviolet ray lamp 70M irradiates ultraviolet rays of about 385 nm band so as to fix the magenta image formed in the magenta recording layer 30. Lastly, a third thermal head 60C applies thermal energy of a high level to render cyan color in the cyan recording layer 20.

The above-described conventional technique is disadvantageous because the image forming process is lengthy, since the color-rendering and color-fixing operations for three different colors are necessary, and expensive, since at least two or more ultraviolet ray lamps irradiating light with different wavelength bands are required.

Another approach to form a multi-color image uses multi-color thermo-sensitive recording materials as disclosed in U.S. Pat. No. 4,665,410. According to the disclosed technique, thermo-sensitive recording layers and decolorizing intermediate layers are consecutively stacked on each other above a base layer. The decolorizing intermediate layers can fix colors rendered in the thermo-sensitive recording layers. The technique is advantageous since one thermal head is enough to render colors in three thermo-sensitive recording layers. However, the thermal head should be accurately controlled so as to satisfy different color-rendering conditions of the thermo-sensitive recording layers. If not, the quality of an image is degraded.

### SUMMARY OF THE INVENTION

The present invention provides a thermo-sensitive recording medium on which a multi-color image can be formed at low cost, a thermo-sensitive recording apparatus and method for forming a multi-color image on the thermo-sensitive recording medium.

The present invention also provides a thermo-sensitive recording medium that allows easy control for rendering colors on recording layers, a thermo-sensitive recording apparatus, and method for forming a multi-color image on the thermo-sensitive recording medium.

According to an aspect of the present invention, a thermo-sensitive recording medium is provided, on a top surface of which a multi-color image is formed, the medium including: a transparent base layer limiting thermal color-rendering interference; a first thermo-sensitive recording layer stacked on the base layer, in which a first color is rendered by heating; a second thermo-sensitive recording layer formed under the base layer, in which a second color is rendered by heating; and a thermo-sensitive magnetic recording layer formed under the second thermo-sensitive recording layer and having a matrix resin that is melted by heating until it reaches a fluid state and in which a plurality of third colored magnetic particles are uniformly dispersed in the lower portion of the matrix resin.

One of the first, second, and third colors may be cyan, one of the other two colors may be magenta, and the last color may be yellow.

The matrix resin is, for example, an opaque polymer resin.

The thermo-sensitive recording medium may further include an intermediate layer between the second thermo-sensitive recording layer and the thermo-sensitive magnetic recording layer.

According to another aspect of the present invention, a thermo-sensitive recording apparatus is provided for forming a multi-color image on the top surface of a thermo-sensitive recording medium, the apparatus including: at least one thermal head that has a plurality of heating elements for heating the thermo-sensitive recording medium to produce first and second colors by selective heating of the heating elements, and to melt a matrix resin of the thermo-sensitive recording medium; and a magnetic head having a plurality of magnetic poles placed opposite to the top surface of the thermo-sensitive recording medium for selectively applying a magnetic force to the melted matrix resin to move magnetic particles in the melted matrix upwardly, thereby providing a third color.

The thermo-sensitive recording apparatus may further include: a first thermal head placed opposite to the top surface of the thermo-sensitive recording medium for heating the first thermo-sensitive recording layer; and a second thermal head placed opposite to the bottom surface of the thermo-sensitive recording medium for heating the second thermo-sensitive recording layer and the thermo-sensitive magnetic recording layer.

The thermo-sensitive recording apparatus may further include a cooling head for cooling down the matrix resin to solidify the third colored thermo-sensitive magnetic recording layer.

According to still another aspect of the present invention, a thermo-sensitive recording method is provided for forming a multi-color image on the top surface of a thermo-sensitive recording medium, the method including: producing a first color by selectively heating a first thermo-sensitive recording layer of the thermo-sensitive recording medium; producing a second color by selectively heating a second thermo-sensitive recording layer of the thermo-sensitive recording medium; and producing the third color by an upward movement of magnetic particles in a melted matrix resin of the thermo-sensitive recording medium by selectively applying a magnetic force to the melted matrix resin by selectively heating a thermo-sensitive magnetic recording layer.

The thermo-sensitive recording method may further include a step of cooling down the matrix resin to be solidified in the third colored thermo-sensitive magnetic recording layer.

According to yet another aspect of the present invention, a thermo-sensitive recording medium is provided having a bottom surface for forming a multi-color image, the medium including: a transparent base layer limiting thermal color-rendering interference; a first thermo-sensitive recording layer formed under the base layer for producing a first color by heating; a second thermo-sensitive recording layer stacked on the base layer for producing a second color by heating; and a thermo-sensitive magnetic recording layer formed on the second thermo-sensitive recording layer, and having a matrix resin that is melted by heating to a fluid state, and in which a plurality of third colored magnetic particles are uniformly dispersed in an upper portion of the matrix resin.

One of the first, second, and third color may be cyan, one of the other two colors may be magenta, and the last color may be yellow.

The matrix resin is, for example, an opaque polymer resin.

The thermo-sensitive recording medium may further include an intermediate layer between the second thermo-sensitive recording layer and the thermo-sensitive magnetic recording layer.

A melting temperature Tₘ of the matrix resin may be higher than a second color-rendering temperature T₂.

According to another aspect of the present invention, there is provided a thermo-sensitive recording apparatus for forming a multi-color image on the bottom surface of a thermo-sensitive recording medium, the apparatus including: at least one thermal head having a plurality of heating elements for heating the thermo-sensitive recording medium to produce first and second colors by selective heating of the heating elements, and to melt a matrix resin of the thermo-sensitive recording medium; and a magnetic head having a plurality of magnetic poles placed opposite to the bottom surface of the thermo-sensitive recording medium and for selectively applying a magnetic force to the melted matrix resin to move magnetic particles in the melted matrix downwardly, thereby rendering a third color.

The thermo-sensitive recording apparatus may further include: a first thermal head placed opposite to the bottom surface of the thermo-sensitive recording medium for heating the first thermo-sensitive recording layer; and a second thermal head placed opposite to the top surface of the thermo-sensitive recording medium for heating the second thermo-sensitive recording layer and the thermo-sensitive magnetic recording layer.

According to another aspect of the present invention, a thermo-sensitive recording method is provided for forming a multi-color image on the bottom surface of the thermo-sensitive recording medium, the method including: producing a first color by selectively heating the first thermo-sensitive recording layer of the thermo-sensitive recording medium; producing a second color by selectively heating the second thermo-sensitive recording layer of the thermo-sensitive recording medium; and producing a third color by a downward movement of magnetic particles in the melted matrix resin by selectively applying a magnetic force to the melted matrix resin by selectively heating the thermo-sensitive magnetic recording layer.

A melting temperature Tₘ of the matrix resin in the thermo-sensitive recording medium may be higher than second color-rendering temperature T₂ and the second thermo-sensitive recording layer may be heated between T₂ and Tₘ during the second color-rendering, and the thermo-sensitive magnetic recording layer may be heated above Tₘ during the third color-rendering.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of an example of a conventional thermo-sensitive recording medium;

FIG. 2 is a schematic view of a structure of a thermo-sensitive printer that forms an image on a thermo-sensitive recording medium as shown in FIG. 1;

FIG. 3 is a cross-sectional view of a thermo-sensitive recording medium according to an embodiment of the present invention;

FIG. 4 is a cross-sectional view of a thermo-sensitive recording medium according to another embodiment of the present invention;

FIG. 5 illustrates the structure of a thermo-sensitive recording apparatus according to an embodiment of the present invention;

FIG. 6A and 6B illustrate sequential formation of an image on the thermo-sensitive recording medium of FIG. 3;

FIG. 7 illustrates sequential color-rendering on thermo-sensitive magnetic recording layers of the thermo-sensitive recording medium of FIG. 3;

FIG. 8 illustrates the structure of a thermo-sensitive recording apparatus according to another embodiment of the present invention;

FIG. 9A and 9B illustrate sequential formation of an image on the thermo-sensitive recording medium of FIG. 4; and

FIG. 10 illustrates the sequential color-rendering on thermo-sensitive magnetic recording layers of the thermo-sensitive recording medium of FIG. 4.

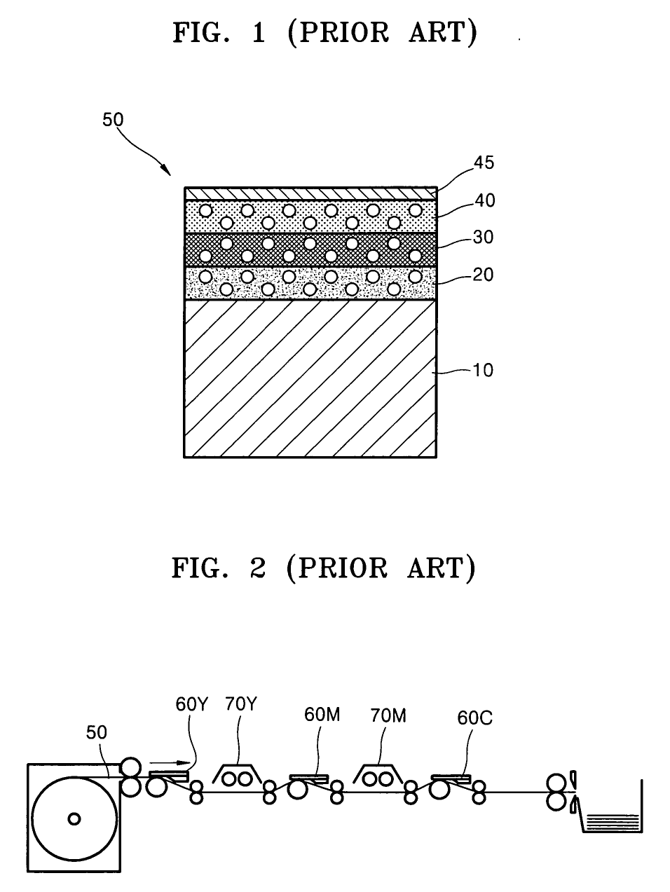

### DETAILED DESCRIPTION OF THE INVENTION

Hereinafter, a thermo-sensitive recording medium, apparatus, and method according to preferred embodiments of the present invention will be described in detail with reference to the attached drawings. It will also be understood that when a layer is referred to as being “on” or “under” another layer or substrate, it can be directly on or under the other layer or substrate, or intervening layers may also be present.

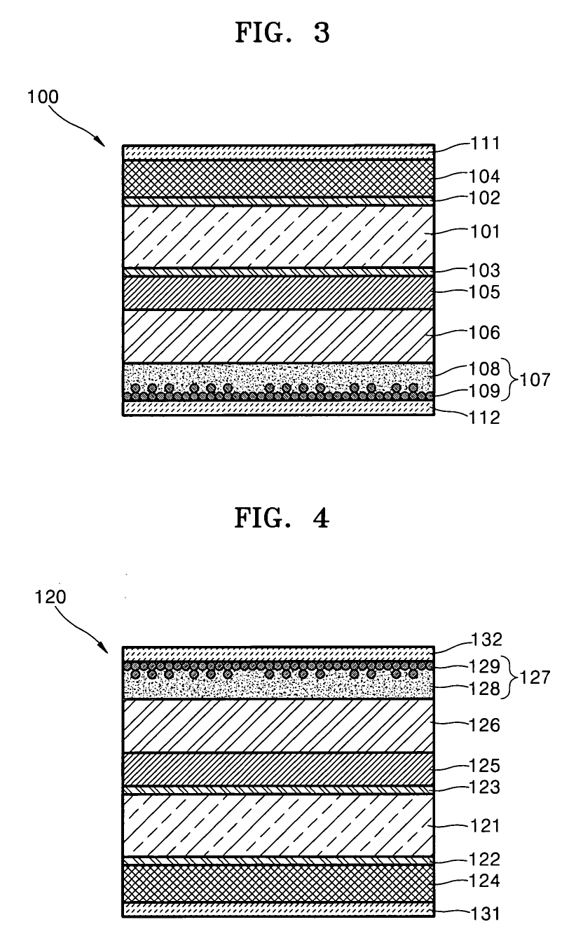

FIG. 3 is a cross-sectional view of a thermo-sensitive recording medium 100 according to an embodiment of the present invention. Referring to FIG. 3, the thermo-sensitive recording medium 100 has a stacked or layered structure in which a first thermo-sensitive recording layer 104 is stacked on a base layer 101 and a second thermo-sensitive recording layer 105 and a thermo-sensitive magnetic recording layer 107 are formed under the base layer 101. A color image is formed on the top surface of the thermo-sensitive recording medium 100.

The base layer 101 supports the recording layers 104, 105, and 107. The base layer 101 is made of a film form of, for example, polyester resins, polyvinylchloride, polystyrene resins, and acrylic resins. The base layer 101 is light transparent because each of images formed on the second thermo-sensitive recording layer 105 and the thermo-sensitive magnetic recording layer 107 should be visible on the top surface of the thermo-sensitive recording medium 100.

In the thermo-sensitive recording medium 100, the base layer 101 is positioned between the first thermo-sensitive recording layer 104 and the second thermo-sensitive recording layer 105 and limits the color-rendering interference between the two recording layers 104 and 105. That is, the base layer 101, formed as a comparatively thick film, functions as an insulation layer to restrain or delay heat transfer, thereby preventing inferior color-rendering in the first and second thermo-sensitive recording layers 104 and 105, even when color-rendering temperatures of the first and second thermo-sensitive recording layers 104 and 105 are not precisely controlled.

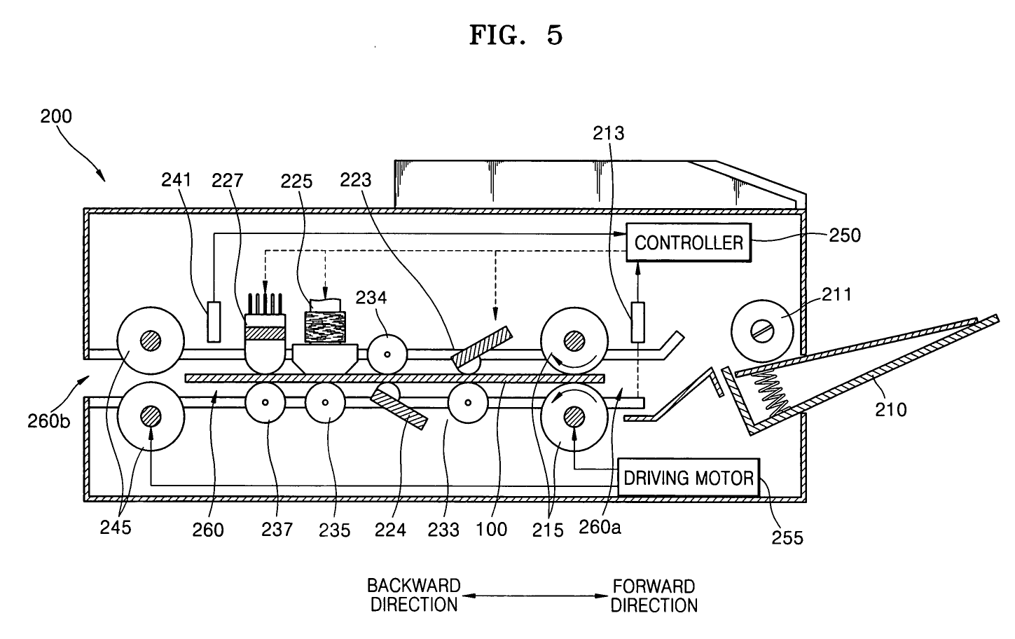

The first and second thermo-sensitive recording layers 104 and 105 are dye layers that render specific colors by thermal activation. The thermo-sensitive recording layers 104 and 105 include color-rendering materials directly or indirectly rendering colors by heat transferred from thermal heads (see FIG. 5). The direct color-rendering materials by heating are characterized in that their chemical or crystalline structures change, or separation of leaving groups therefrom at a certain temperature. The indirect color-rendering materials are mixtures of developers and color precursors, or mixtures of microcapsules having developers or couplers and color precursors. The developer is activated at a certain temperature to generate an acid and the color precursor reacts with the generated acid to produce a color. In addition, the microcapsule may be formed from materials whose permeation degrees with the developers, the couplers, or the color precursors vary with a predetermined temperature. The color precursors may be leuco dyes.

The first and second thermo-sensitive recording layers 104 and 105 are made of a synthetic resin having light transparency and good film formation, such as gelatin, polyvinylchloride, polystyrene, polyester, polyurethane, polycarbonate, polyacrylate, polyvinylalcohol, etc.

Undercoating layers 102 and 103 as a binder are inserted between the base layer 101 and the first thermo-sensitive recording layer 104, and between the base layer 101 and the second thermo-sensitive recording layer 105, respectively. The undercoating layers 102 and 103 are formed of a two-liquid typed primer, for example, polyol and polyisocyanate, or a one-liquid typed primer, for example, an acrylic polymer, a urethane polymer, an acrylic-urethane polymer, and a vinyl polymer.

Colors rendered in the first and second thermo-sensitive recording layers 104 and 105 have different color tones. As described above, the thermal interference between the first thermo-sensitive recording layer 104 and the second thermo-sensitive recording layer 105 can be restrained by the base layer 101 inserted between the two layers 104 and 105. However, to further reliably prevent inferior color-rendering, the thermo-sensitive recording layers 104 and 105 are formed of different dye layers having different color-rendering conditions, such as color-rendering temperature and heating time required for color-rendering.

The thermo-sensitive magnetic recording layer 107 is a mixture of a matrix resin 108 and magnetic particles 109. The matrix resin 108 is, for example, a hydrocarbon group polymer resin. The fluidity of the matrix resin 108 is greatly changed around its melting temperature Tₘ. In other words, when heated above the melting temperature Tₘ, the matrix resin 108 has a fluid-like consistency such that the magnetic particles 109 uniformly disperse in the lower portion of the matrix resin 108 can be attracted upwardly by an external magnetic force. When cooled down below the melting temperature Tₘ, the fluidified matrix resin 108 is solidified and loses its fluidity such that the magnetic particles 109 are set in the matrix resin 108 and restrained from movement. The magnetic particles 109 are, for example, metallic powders, such as magnetic binder solidified fine particle ferrites, spherically sintered ferrites, fine sintered ferrites, and crystallized ferrites. The magnetic particles 109 may be colored by surface coating with a certain color dye.

The color of the matrix resin 108 is opaque, preferably white, because the color of the magnetic particles 109 in the lower portion thereof should not be shown on the top surface of the thermo-sensitive recording medium 100. However, the background color of the thermo-sensitive recording medium 100 should be shown and visible on the top surface of the thermo-sensitive recording medium 100.

An intermediate layer 106 inserted between the second thermo-sensitive recording layer 105 and the thermo-sensitive magnetic recording layer 107 restrains heat transfer. The intermediate layer 106 is formed of a non-active material or a thermal phase transforming material, for example, polyvinylalcohol.

A protect layer 111 is stacked or layered on the first thermo-sensitive recording layer 104 and another protect layer 112 is formed under the thermo-sensitive magnetic recording layer 107. The protect layers 111 and 112 protect the inner recording layers 104, 105, and 107 from thermal shock, physical shock, or exfoliation. The protect layers 111 and 112 may be formed of a resin having thermal resistivity and flexibility.

Different colors, rendered in the thermo-sensitive magnetic recording layer 107, the first thermo-sensitive recording layer 104, and the second thermo-sensitive recording layer 105, can be mixed to form a full color image on the top surface of the thermo-sensitive recording medium 100. If, for example, cyan is rendered in the thermo-sensitive magnetic recording layer 107, magenta is rendered in the first thermo-sensitive recording layer 104, and yellow is rendered in the second thermo-sensitive recording layer 105, a full colored image can be formed by the combination of these three basic colors.

FIG. 4 is a cross-sectional view of a thermo-sensitive recording medium 120 according to another embodiment of the present invention. The thermo-sensitive recording medium 120 illustrated in FIG. 4 includes a base layer 121 and layers supported by the base layer 121, such as a first thermo-sensitive recording layer 124, a second thermo-sensitive recording layer 125, and a thermo-sensitive magnetic recording layer 127. In the thermo-sensitive recording medium 120, the first thermo-sensitive recording layer 124 is formed under the base layer 121 and the second thermo-sensitive recording layer 125 and the thermo-sensitive magnetic recording layer 127 are stacked on the base layer 121.

A color image is formed on the bottom surface of the thermo-sensitive recording medium 120. The base layer 121 is a transparent thick film and limits the color-rendering interference between the first thermo-sensitive recording layer 124 and the second thermo-sensitive recording layer 125. A first color is rendered in the first thermo-sensitive recording layer 124 by heating and a second color different from the first color is rendered in the second thermo-sensitive recording layer 125 by heating.

The thermo-sensitive magnetic recording layer 127 stacked on the second thermo-sensitive recording layer 125 is a mixture of a matrix resin 128 and magnetic particles 109 uniformly dispersed in the upper portion of the matrix resin 128. The magnetic particles 129 are colored with a third color different from the first and second colors. For example, in the embodiment in the FIG. 4, the first color is magenta M, the second color is yellow Y, and the third color is cyan C.

The melting temperature Tₘ of the matrix resin 128 is higher than a second color-rendering temperature T₂. Otherwise, when the second thermo-sensitive recording layer 125 is heated for rendering a color, the matrix resin 128 is melted such that the magnetic particles 129 fall due to their weight and are dispersed in the lower portion of the thermo-sensitive magnetic recording layer 127, thereby rendering an inferior color.

An intermediate layer 126 is inserted to restrain the heat transfer between the second thermo-sensitive recording layer 125 and the thermo-sensitive magnetic recording layer 127. In addition, undercoating layers 122 and 123 as a binder are inserted between the base layer 121 and the first thermo-sensitive recording layer 124 and between the base layer 121 and the second thermo-sensitive recording layer 125, respectively. The protect layers 131 and 132 are formed on the top and bottom surfaces of the thermo-sensitive recording medium 120 to protect the inner stacked structure.

FIG. 5 illustrates the structure of a thermo-sensitive recording apparatus 200 according to an embodiment of the present invention. Referring to FIG. 5, the thermo-sensitive recording apparatus 200 includes a feeding cassette 210, a pickup roller 211 picking up a sheet of a thermo-sensitive recording medium 100 stacked in the feeding cassette 210, front and rear transport rollers 215 and 245 transporting the thermo-sensitive recording medium 100 along a transport pathway 260, and thermal heads 223 and 224 and a magnetic head 225 thermally or magnetically recording an image on the thermo-sensitive recording medium 100. Specifically, the thermo-sensitive recording medium 100 is transported along the transport pathway 260 by a pair of the front transport rollers 215 rotating in reverse directions with respect to each other and an image is recorded during the transport process. One of the front transport rollers 215 is a driving roller driven by a driving motor 255 and the other one is a passive roller driven by the driving roller. In addition, the rear transport rollers 245 arranged at the rear end of the transport pathway 260 may have basically the same structure as the front transport rollers 215.

The first and second thermal head 223 and 224, the magnetic head 225, and a cooling head 227 are consecutively arranged along the transport pathway 260. The first thermal head 223, the magnetic head 225, and the cooling head 227 face the top surface of a thermo-sensitive recording medium 100, while the second thermal head 224 faces the bottom surface of the thermo-sensitive recording medium 100. The thermal heads 223 and 224 include a plurality of heating elements (not illustrated) arranged along the width of the thermo-sensitive recording medium 100. The heating elements are, for example, fine electric resistors. A predetermined electric current is selectively supplied to the heating elements under the control of a controller 250, and thus the portions of the thermo-sensitive recording medium 100 facing the heating elements where the electric current is supplied is heated. The pressing rollers 233 and 234, respectively arranged opposite to the thermal heads 223 and 224, press the thermo-sensitive recording medium 100 to be in close contact with the thermal heads 223 and 224, thereby preventing inferior color-rendering.

The magnetic head 225 is in close contact with the pressing roller 235 placed opposite thereto and the thermo-sensitive recording medium 100 is transported between them while contacting the magnetic head 225. The magnetic head 225 includes a plurality of fine magnetic poles (not illustrated) arranged along the width of the thermo-sensitive recording medium 100. The fine magnetic poles may be permanent magnets or electromagnets. When the magnetic poles of the magnetic head 225 are permanent magnets, an on/off magnetic force can be controlled by the upward/downward movement of the permanent magnets with respect to the thermo-sensitive recording medium 100. When the magnetic poles of the magnetic head 225 are electromagnets, the on/off magnetic force can be controlled by a current supplied to the electromagnet.

The cooling head 227 compulsively cools down the thermo-sensitive magnetic recording layer 107 after color-rendering caused by the magnetic head 225 (see FIG. 3) and is elastically pressed by the pressing roller 237 placed opposite thereto. The cooling head 227 can be formed of a thermoelectric transformation module including Peltier effect metal or semiconductor.

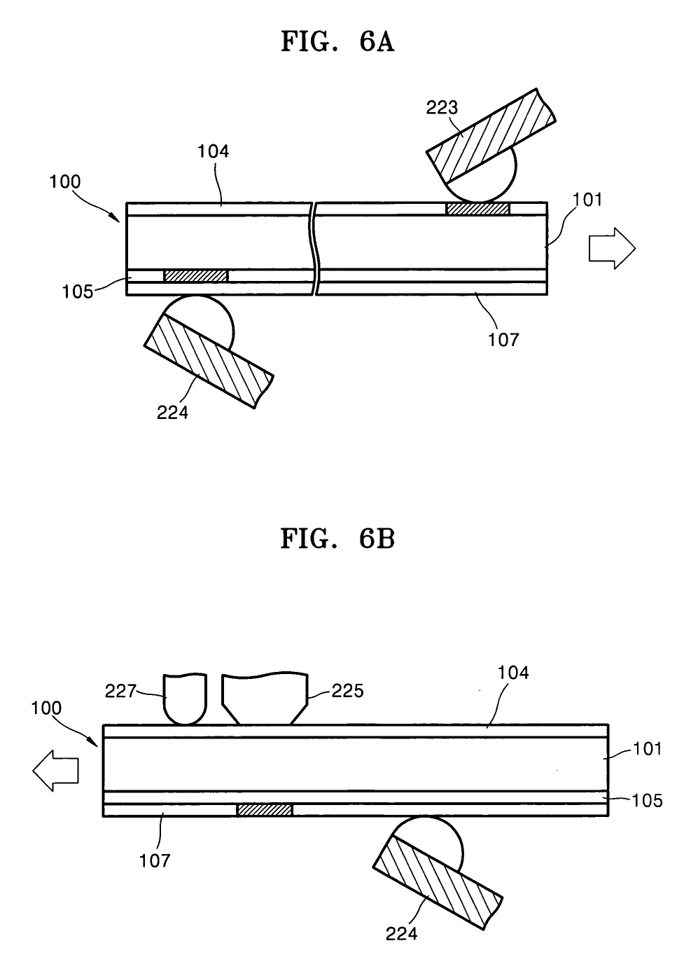

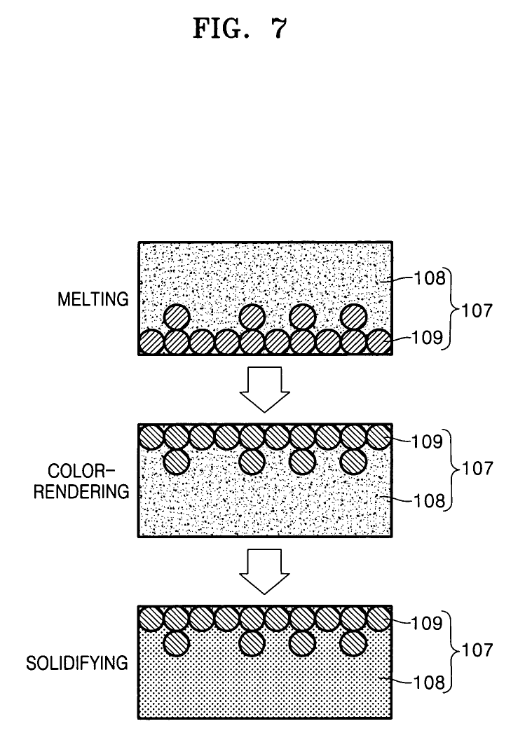

FIG. 6A and 6B illustrate sequential formation of an image in the thermo-sensitive recording medium of FIG. 3. FIG. 7 illustrates sequential color-rendering in the thermo-sensitive magnetic recording layer of the thermo-sensitive recording medium of FIG. 3. In the FIG. 6A and 6B, the thermo-sensitive recording medium 100 is schematically illustrated. Hereinafter, the operation of the thermo-sensitive recording apparatus 200 illustrated in FIG. 5 will be described with reference to FIGS. 6A, 6B and 7.

First, a thermo-sensitive recording medium 100 stacked in the feeding cassette 210 is picked up by the pickup roller 211 and transported from a front open end 260a to a rear open end 260b by the front transport rollers 215. When the thermo-sensitive recording medium 100 reaches the rear open end 260b, the rear transport rollers 245 is reversely driven, and accordingly, the thermo-sensitive recording medium 100 is reversely transported toward the front open end 260a, thereby color-rendering appearing in the first and second thermo-sensitive recording layers 104 and 105. A position detecting sensor 241 installed near the rear open end 260b senses the arrival of the thermo-sensitive recording medium 100 and transmits a sensing signal to a controller 250. The rear transport rollers 245 are rotated in opposite directions under the control of the controller 250.

When the thermo-sensitive recording medium 100 is transported from the rear open end 260b to the front open end 260a, the first thermo-sensitive recording layer 104 and the second thermo-sensitive recording layer 105 in the thermo-sensitive recording medium 100 are selectively heated by the first thermal head 223 and the second thermal head 224, respectively. Accordingly, a first color, for example, magenta M, and a second color, for example, yellow Y, are produced, respectively. FIG. 6a illustrates color-rendering caused by selectively heating the first and second thermo-sensitive recording layers 104 and 105 above color-rendering temperatures.

When the thermo-sensitive recording medium 100 is close to the front open end 260a after passing the thermal heads 223 and 224, a front position detecting sensor 213 installed above the transport pathway 260 senses the arrival of the thermo-sensitive recording medium 100 and the front transport rollers 215 are rotated in opposite directions under the control of the controller 250 based on a sensing signal from the front position detecting sensor 213. Accordingly, the thermo-sensitive recording medium 100 is transported again toward the rear open end 260b and another color is rendered in the thermo-sensitive magnetic recording layer 107.

The thermo-sensitive recording medium 100 transported toward the rear open end 260b is heated by the second thermal head 224, and then the matrix resin 108 in the thermo-sensitive magnetic recording layer 107 is selectively heated above the melting temperature Tₘ of the matrix resin 108. Accordingly, the matrix resin 108 is selectively melted and the magnetic particles 109 therein can be smoothly moved. The thermo-sensitive recording medium 100 passing the second thermal head 224 consecutively contacts the magnetic head 225 and a magnetic force is applied thereto, such that the movable magnetic particles 109 dispersed in the melted matrix resin 108 ascend. The magnetic particles 109 ascending toward the upper portion of the thermo-sensitive magnetic recording layer 107 render a third color, for example, cyan C, in the thermo-sensitive recording medium 100.

Meanwhile, if the matrix resin 108 maintains its fluidity during the above processes, the magnetic particles 109 ascended by the magnetic force descend again due to their own weight, resulting in inferior color-rendering of the third color. To prevent this, the cooling head 227 cools down the thermo-sensitive recording medium 100 that passed the magnetic head 225 so as to immediately solidify the matrix resin 108. Consequently, when the matrix resin 108 is cooled down below the melting temperature Tₘ and solidified, the magnetic particles 109 maintain their changed positions.

The thermo-sensitive recording medium 100 on a top surface of which a multi-color image is formed due to the first, the second, and third color-renderings is discharged via the rear open end 260b by the rotation of the rear transport rollers 245.

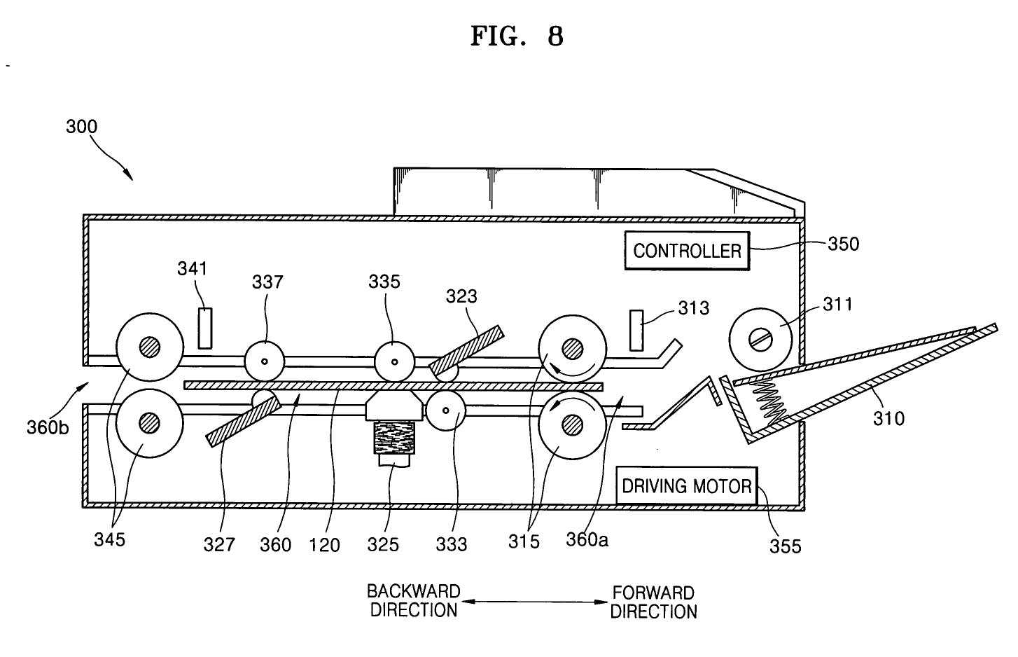

FIG. 8 illustrates the structure of a thermo-sensitive recording apparatus 300 for forming an image on the thermo-sensitive recording medium 120 illustrated in FIG. 4. Referring to FIG. 8, the thermo-sensitive recording apparatus 300 includes a feeding cassette 310, a pickup roller 311 for picking up a sheet of thermo-sensitive recording media 120 stacked in the feeding cassette 310, front and rear transport rollers 315 and 345 for transporting the thermo-sensitive recording medium 120 along a transport pathway 360, and thermal heads 323 and 327 and a magnetic head 325 thermally or magnetically recording an image on the thermo-sensitive recording medium 120. Specifically, a thermo-sensitive recording medium 120 is transported by a pair of the front transport rollers 315 reversely rotating to each other along the transport pathway 360 and an image is recorded during the transport process. One of the front transport rollers 315 is a driving roller driven by a driving motor 355 and the other one is a passive roller driven by the driving roller. In addition, the rear transport rollers 345 arranged at the rear end of the transport pathway 360 may have basically the same structure as the front transport rollers 315.

The second thermal head 323, the magnetic head 325, and the first thermal head 327 are consecutively arranged along the transport pathway 360. The first thermal head 327 and the magnetic head 325 face the bottom surface of a thermo-sensitive recording medium 120, while the second thermal head 323 faces the top surface of the thermo-sensitive recording medium 120. Since the structures of the thermal heads 323 and 327 are the same as those of the thermal heads 223 and 224 in FIG. 5, a detail description thereof will be omitted. The pressing rollers 333 and 334, respectively are arranged opposite the thermal heads 323 and 327, and press the thermo-sensitive recording medium 120 in close contact with the thermal heads 323 and 327, thereby preventing inferior color-rendering.

The magnetic head 325 is in close contact with the pressing roller 335 placed opposite thereto and the thermo-sensitive recording medium 120 is transported between them while contacting the magnetic head 325. Since the structure of the magnetic head 325 is also the same as that of the magnetic head 225 in FIG. 5, a detail description thereof will be omitted.

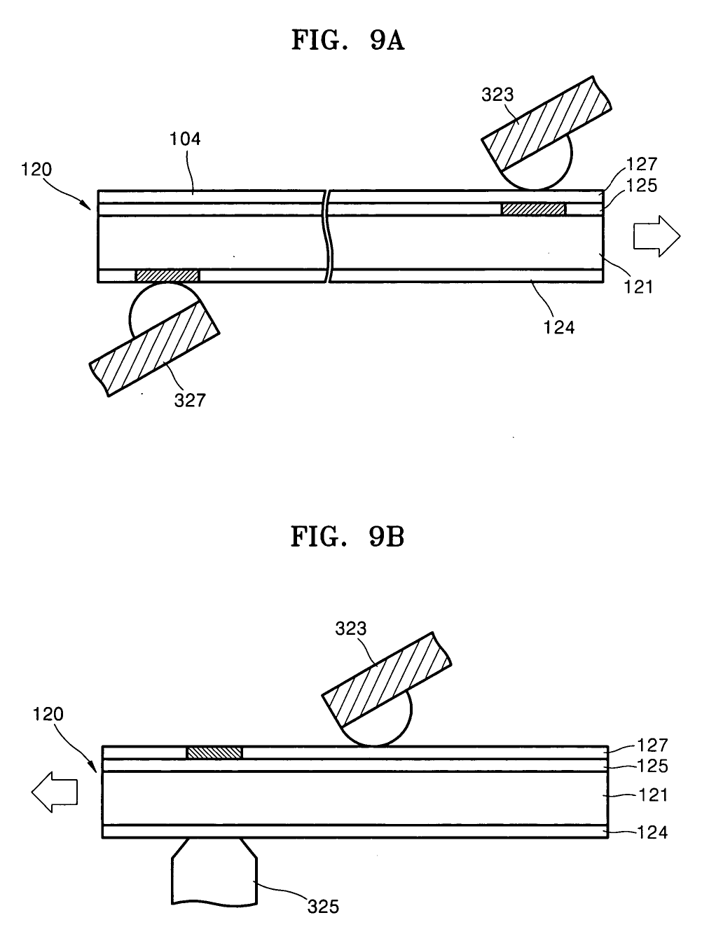

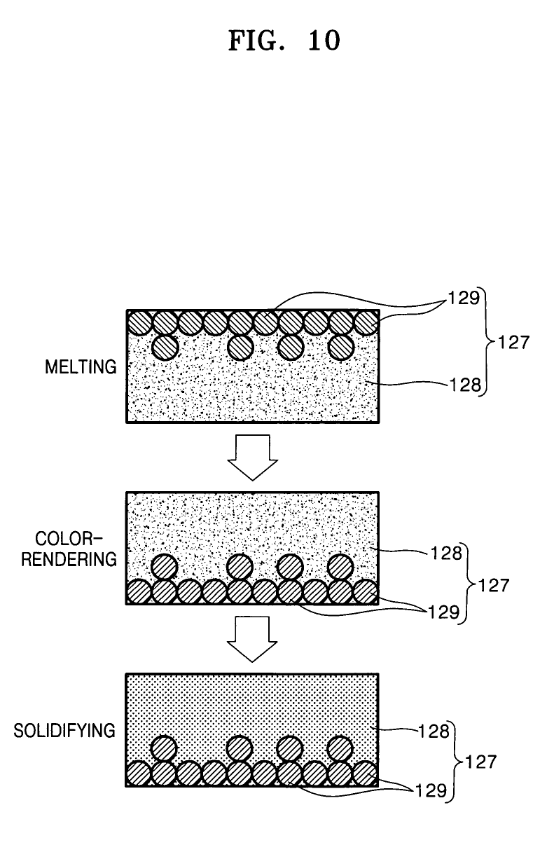

FIG. 9A and 9B illustrate sequential formation of an image in the thermo-sensitive recording medium of FIG. 4. FIG. 10 illustrates sequential color-rendering in thermo-sensitive magnetic recording layer of the thermo-sensitive recording medium of FIG. 4. In FIG. 9A and 9B, the thermo-sensitive recording medium 120 is schematically illustrated. Hereinafter, the operation of the thermo-sensitive recording apparatus 300 illustrated in FIG. 8 will be described with reference to FIGS. 9A, 9B and 10.

First, a thermo-sensitive recording medium 120 stacked in the feeding cassette 310 is picked up by the pickup roller 311 and transported from a front open end 360a to a rear open end 360b by the front transport rollers 315. When the thermo-sensitive recording medium 120 reaches the rear open end 360b, the rear transport rollers 345 are driven in opposite directions, and accordingly, the thermo-sensitive recording medium 120 is transported in a reverse direction toward the front open end 360a, thereby color-rendering appearing in the first and second thermo-sensitive recording layers 124 and 125. A position detecting sensor 341 installed near the rear open end 360b senses the arrival of the thermo-sensitive recording medium 120 and transmits a sensing signal to a controller 350. The rear transport rollers 345 are reversely rotated under the control of the controller 350.

When the thermo-sensitive recording medium 120 is transported from the rear open end 360b to the front open end 360a, the first thermo-sensitive recording layer 124 and the second thermo-sensitive recording layer 125 in the thermo-sensitive recording medium 120 are selectively heated by the first thermal head 327 and the second thermal head 323, respectively. Accordingly, a first color, for example, magenta M, and a second color, for example, yellow Y, are rendered, respectively. FIG. 9a illustrates color-rendering caused by selectively heating the first and second thermo-sensitive recording layers 124 and 125 above color-rendering temperatures.

The second color-rendering temperature T₂ for the second thermo-sensitive recording layer 125 is lower than the melting temperature Tₘ of the matrix resin 128 in the thermo-sensitive magnetic recording layer 127. If the T₂ is higher than the Tₘ, the heating by the second thermal head 323 simultaneously causes a second color-rendering in the second thermo-sensitive recording layer 125 and melting of the matrix resin 128 in the thermo-sensitive magnetic recording layer 127 such that the magnetic particles 129 descend to the lower portion of the thermo-sensitive magnetic recording layer 127 due to their weight, resulting in unexpectedly rendering a third color.

When the thermo-sensitive recording medium 120 is close to the front open end 360a after passing the thermal heads 323 and 327, a front position detecting sensor 313 installed above the transport pathway 360 senses the arrival of the thermo-sensitive recording medium 120 and the front transport rollers 315 are reversely rotated under the control of the controller 350 based on a sensing signal form the front position detecting sensor 313. Accordingly, the thermo-sensitive recording medium 120 is transported again toward the rear open end 360b and another color is rendered in the thermo-sensitive magnetic recording layer 107.

The thermo-sensitive recording medium 120 transported toward the rear open end 360b is heated by the second thermal head 323, and then the matrix resin 128 in the thermo-sensitive magnetic recording layer 127 is selectively heated above the melting temperature Tₘ of the matrix resin 128. Accordingly, the matrix resin 128 is selectively melted and the magnetic particles 129 therein can be smoothly moved. The thermo-sensitive recording medium 120 passing the second thermal head 323 consecutively contacts the magnetic head 325 and a magnetic force is applied thereto, such that movable magnetic particles 129 dispersed in the melted matrix resin 108 descend. The magnetic particles 129 descending toward the lower portion of the thermo-sensitive magnetic recording layer 127 to produce a third color, for example, cyan C, in the thermo-sensitive recording medium 120. The magnetic particles 129 moved toward the lower portion of the thermo-sensitive magnetic recording layer 127 by the magnetic head 325 stably maintain their position due to their weight. Accordingly, even though the matrix resin 128 is gradually solidified at room temperature, the image of the third color formed in the thermo-sensitive magnetic recording layer 127 can be conserved as it is. Therefore, the cooling head 227 in the thermo-sensitive recording apparatus 200 of FIG. 5 may not be necessary.

The thermo-sensitive recording medium 120 on a bottom surface of which a multi-color image is formed under due to the first, the second, and third color-rendering is discharged via the rear open end 360b by the rotation of the rear transport rollers 345.

A thermo-sensitive recording medium, apparatus, and method according to the present invention can easily control color-rendering of the recording layers, thereby forming a high quality multi-color image with clear color tones and sharp outlines. In addition, the structure of the thermo-sensitive recording apparatus for color-rendering can be simplified, thereby reducing printing cost.

While the present invention has been particularly shown and described with reference to exemplary embodiments thereof, it will be understood by those of ordinary skill in the art that various changes in form and details may be made therein without departing from the spirit and scope of the present invention as defined by the following claims. For examples, a thermo-sensitive recording apparatus according to an embodiment of the present invention may have one movable thermal head used for color-rendering of first and second thermo-sensitive recording layers of a thermo-sensitive recording medium, or in which a thermo-sensitive recording medium is overturned and transported for rendering colors in the first and second thermo-sensitive recording layers with one thermal head. Therefore, the scope of the present invention is defined not by the detailed description of the invention but by the following claims.

What is claimed is:

1. A thermo-sensitive recording medium, on a top surface of which a multi-color image is formed, the medium comprising:
a transparent base layer limiting thermal color-rendering interference having first and second sides;
a first thermo-sensitive recording layer formed on the first side of the base layer for producing a first color by heating;
a second thermo-sensitive recording layer formed under the second side of the base layer for producing a second color by heating; and
a thermo-sensitive magnetic recording layer which is formed on the second thermo-sensitive recording layer, and having a matrix resin that melts to a fluid state by heating, said matrix resin having a plurality of colored magnetic particles uniformly dispersed in a lower portion thereof, said colored magnetic particles being a third color.

2. The medium of claim 1, wherein one of the first, second, and third colors is cyan, one of the other two colors is magenta, and the last color is yellow.

3. The medium of claim 1, wherein the matrix resin is an opaque polymer resin.

4. The medium of claim 1 further comprising an intermediate layer between the second thermo-sensitive recording layer and the thermo-sensitive magnetic recording layer.

5. A thermo-sensitive recording medium having a bottom surface for forming a multi-color image, the medium comprising;
a transparent base layer limiting thermal color-rendering interference and having a first side and a second side;
a first thermo-sensitive recording layer formed on the first side of the base layer for forming a first color by heating;
a second thermo-sensitive recording layer formed on a second side of the base layer for forming a second color by heating; and
a thermo-sensitive magnetic recording layer which is formed on the second thermo-sensitive recording layer and having a matrix resin that melts to a fluid state by heating, said matrix resin having a plurality of colored magnetic particles uniformly dispersed in an upper portion thereof, said colored magnetic particles being a third color.

6. The medium of claim 5, wherein one of the first, second, and third colors is cyan, one of the other two colors is magenta, and the last color is yellow.

7. The medium of claim 5, wherein the matrix resin is an opaque polymer resin.

8. The medium of claim 5 further comprising an intermediate layer between the second thermo-sensitive recording layer and the thermo-sensitive magnetic recording layer.

9. The medium of claim 5, wherein the matrix resin has a melting temperature Tₘ higher than a second color-rendering temperature T₂.

10. A thermo-sensitive recording apparatus for forming a multi-color image on a top surface of a thermo-sensitive recording medium comprising a transparent base layer limiting thermal color-rendering interference and having a first and second side, a first thermo-sensitive recording layer formed on the first side of the base layer for producing a first color by heating, a second thermo-sensitive recording layer formed under the second side of the base layer for forming a second color by heating; and a thermo-sensitive magnetic recording layer formed on the second thermo-sensitive recording layer and having a matrix resin that melts to a fluid state by heating, said matrix resin having a plurality of colored magnetic particles uniformly dispersed in a lower portion thereof, said colored magnetic particles being a third color, the apparatus comprising:
at least one thermal head having a plurality of heating elements for heating the thermo-sensitive recording medium, and producing the first and second colors by selective heating of the heating elements, and to melt the matrix resin; and
a magnetic head having a plurality of magnetic poles placed opposite to a top surface of the thermo-sensitive recording medium and selectively applying a magnetic force to the melted matrix resin to move the magnetic particles upwardly in the melted matrix, thereby producing the third color.

11. The apparatus of claim 10 further comprising:
a first thermal head placed opposite to the top surface of the thermo-sensitive recording medium for heating the first thermo-sensitive recording layer; and
a second thermal head placed opposite to a bottom surface of the thermo-sensitive recording medium for heating the second thermo-sensitive recording layer and the thermo-sensitive magnetic recording layer.

12. The apparatus of claim 10 further comprising a cooling head for cooling down the melted matrix resin to solidify the third colored thermo-sensitive magnetic recording layer.

13. A thermo-sensitive recording apparatus for forming a multi-color image on a bottom surface of a thermo-sensitive recording medium comprising a transparent base layer limiting thermal color-rendering interference and having a first side and a second side, a first thermo-sensitive recording layer formed under the second base layer for producing a first color by heating, a second thermo-sensitive recording layer stacked on a first side of the base layer for producing a second color by heating, and a thermo-sensitive magnetic recording layer which is stacked on the second thermo-sensitive recording layer and having a matrix resin that melts to a fluid state by heating, said matrix resin having a plurality of third colored magnetic particles uniformly dispersed in an upper portion thereof, said colored magnetic particles being a third color, the apparatus comprising:
at least one thermal head having a plurality of heating elements for heating the thermo-sensitive recording medium and producing the first and second colors by selective heating of the heating elements, and to melt the matrix resin; and
a magnetic head having a plurality of magnetic poles placed opposite to the bottom surface of the thermo-sensitive recording medium and selectively applying a magnetic force to the melted matrix resin to move the magnetic particles downwardly in the melted matrix, thereby producing the third color.

14. The apparatus of claim 13 further comprising:
a first thermal head placed opposite to the bottom surface of the thermo-sensitive recording medium for heating the first thermo-sensitive recording layer; and
a second thermal head placed opposite to the top surface of the thermo-sensitive recording medium for heating the second thermo-sensitive recording layer and the thermo-sensitive magnetic recording layer.

15. A thermo-sensitive recording method for forming a multi-color image on a top surface of a thermo-sensitive recording medium comprising a transparent base layer limiting thermal color-rendering interference and having a first side and a second side, a first thermo-sensitive recording layer stacked on a first side of the base layer for producing a first color by heating, a second thermo-sensitive recording layer formed under a second side of the base layer for producing a second color by heating; and a thermo-sensitive magnetic recording layer formed under the second thermo-sensitive recording layer and having a matrix resin that melts to a fluid state by heating, said matrix resin having a plurality of colored magnetic particles uniformly dispersed in a lower portion thereof, said colored magnetic particles being a third color, the method comprising:
producing the first color by selectively heating the first thermo-sensitive recording layer of the thermo-sensitive recording medium;
producing the second color by selectively heating the second thermo-sensitive recording layer of the thermo-sensitive recording medium; and
producing the third color by causing an upward movement of the magnetic particles in the melted matrix resin by selectively applying a magnetic force to the melted matrix resin by selectively heating the thermo-sensitive magnetic recording layer.

16. The method of claim 15 further comprising cooling down the melted matrix resin to solidify the third colored thermo-sensitive magnetic recording layer.

17. A thermo-sensitive recording method for forming a multi-color image on a bottom surface of a thermo-sensitive recording medium comprising a transparent base layer limiting thermal color-rendering interference and having a first side and a second side, a first thermo-sensitive recording layer formed under the second side of the base layer for producing a first color by heating, a second thermo-sensitive recording layer formed on a first side of the base layer for producing a second color by heating, and a thermo-sensitive magnetic recording layer which is stacked on the second thermo-sensitive recording layer and having a matrix resin that melts to a fluid state by heating, said matrix resin having a plurality of colored magnetic particles uniformly dispersed in an upper portion thereof, said colored magnetic particles being a third color, the method comprising:
producing the first color by selectively heating the first thermo-sensitive recording layer of the thermo-sensitive recording medium;
producing the second color by selectively heating the second thermo-sensitive recording layer of the thermo-sensitive recording medium; and
producing the third color by an downward movement of the magnetic particles in the melted matrix resin by selectively applying a magnetic force to the melted matrix resin by selectively heating the thermo-sensitive magnetic recording layer.

18. The method of claim 17, wherein the matrix resin has a melting temperature Tₘ in the thermo-sensitive recording medium is higher than a color-rendering temperature T₂ of the second thermo-sensitive recording layer and heating the second thermo-sensitive recording layer between T₂ and Tₘ during the second color-producing step, and heating the thermo-sensitive magnetic recording layer above Tₘ during the third color-producing step.
